(19) United States
(12) Patent Application Publication
(10) Pub. No.: US 2025/0138892 A1
(43) Pub. Date: May 1, 2025

(54) TASK PROCESSING METHOD AND APPARATUS, DEVICE, AND MEDIUM

(71) Applicant: Beijing Volcano Engine Technology Co., Ltd., Beijing (CN)

(72) Inventors: Fachuan BAI, Beijing (CN); Xuan LUO, Beijing (CN)

(21) Appl. No.: 18/728,800

(22) PCT Filed: Apr. 13, 2022
(86) PCT No.: PCT/CN2023/087972

§ 371 Date: Jul. 12, 2024

(30) Foreign Application Priority Data
Apr. 21, 2022 (CN) 202210422779.0

(51) Int. Cl. G06F 9/50; G06F 16/242

(52) U.S. Cl. CPC G06F 9/5027; G06F 16/2433

(57) ABSTRACT

The present application discloses a task processing method. In the case that a server is started, during the process of starting, the server determines a processing engine which can be warmed up from processing engines included by the server, i.e., a processing engine to be warmed up. After the processing engine to be warmed up is determined, resources are allocated to the processing engine to be warmed up such that the processing engine to be warmed up, when receiving a task processing request, utilizes the allocated resources to process a task indicated by the task processing request. That is, before a processing engine receives a task processing request, desired resources are allocated to the processing engine in advance such that the processing engine, when receiving the task processing request, can execute a task in time without waiting for resource allocation so as to improve the task execution efficiency.

### CROSS-REFERENCE TO RELATED APPLICATIONS

The present application claims the priority of Chinese patent application No. 202210422779.0 filed on Apr. 21, 2022, and entitled “Task processing method and apparatus, device, and medium”, the entire contents of which are incorporated herein by reference.

### FIELD

Embodiments of the present application relate to the technical field of computer, and in particular, to a task processing method, and apparatus, a device, and a medium.

### BACKGROUND

Spark structured query language (Spark SQL) is a module used by Spark to process structured data, which is used as a distributed SQL query engine. Data mining and analysis using a Spark SQL engine is the most current application scenario.

In actual work, when receiving a task to be processed, the Spark SQL engine needs to submit a request to Yet Another Resource Negotiator (Yarn) so as to request Yarn to allocate required resources for the task, and then the Spark SQL engine uses the allocated resources to execute the task. However, with an increase of cluster size, Yarn spends more and more time in resource allocation, which results in long time for the Spark SQL engine to execute tasks and a decrease in task execution efficiency.

### SUMMARY

In view of this, the present application provides a task processing method, and apparatus, a device and a medium, so as to allocate resources for a processing engine in advance. In this way, a task to be processed can be responded in time to improve the task execution efficiency.

In order to achieve the above-mentioned object, the technical solution of the present application is as follows:

In a first aspect of the present application, there is provided a task processing method, wherein the method is applied to a server, comprising:
determining, in response to the server starting, processing engines to be warmed up;
allocating resources for the processing engines to be warmed up such that the processing engines to be warmed up, when receiving a task processing request, process a task indicated by the task processing request using the allocated resources.

In a second aspect of the present application, there is provided a task processing apparatus comprising:
a determination unit for determining, in response to the server starting, processing engines to be warmed up;
an allocation unit for allocating resources for the processing engines to be warmed up such that the processing engines to be warmed up, when receiving a task processing request, process a task indicated by the task processing request using the allocated resources.

In a third aspect of the present application, there is provided an electronic device comprising: a processor and a memory;
the memory for storing instructions or a computer program;
the processor for executing the instructions or computer program in the memory to cause the electronic device to perform the method of the first aspect.

In a fourth aspect of the present application, there is provided a computer readable storage medium having stored therein instructions which, when executed on a device, cause the device to perform the method of the first aspect.

In a fifth aspect of the present application, there is provided a computer program product comprising computer programs/instructions which when executed by a processor implement the method of the first aspect.

It can be seen that the present application possesses the following advantages:

In the present application, in the case that a server is started, during the process of starting, the server determines a processing engine which can be warmed up, i.e., a processing engine to be warmed up, in processing engines comprised by the server. After the processing engine to be warmed up is determined, resources are allocated to the processing engine to be warmed up such that when receiving a task processing request, the processing engine to be warmed up uses the allocated resources to process a task indicated by the task processing request. That is, before a processing engine receives a task processing request, desired resources are allocated to the processing engine in advance such that when receiving the task processing request, the processing engine can execute a task in time, there is no need to wait for resource allocation, and the task execution efficiency is improved

### BRIEF DESCRIPTION OF THE DRAWINGS

In order to explain the technical solutions of the embodiments of the present application more clearly, the following description is given with reference to the drawings which are required to be used in the depiction of the embodiments. It is obvious that the figures in the following description are only for some embodiments of the present application, and a person of ordinary skill in the art would be able to obtain other ones according to these figures without involving any inventive effort.

FIG. 1 is a schematic diagram of a service structure according to an embodiment of the present application;

FIG. 2 is a schematic diagram of an application scenario according to an embodiment of the present application;

FIG. 3 is a flow chart of a task processing method according to an embodiment of the present application;

FIG. 4 is a schematic structural diagram of a task processing apparatus according to an embodiment of the present application;

FIG. 5 is a schematic diagram of an electronic device according to an embodiment of the present application.

### DETAILED DESCRIPTION OF EMBODIMENTS

In order that those skilled in the art may better understand the embodiments of the present invention, a clear and complete description of the embodiments of the present invention is provided below in connection with the accompanying drawings of the embodiments of the present invention. It is to be understood that the embodiments described are only a few, but not all embodiments of the present invention. Based on the embodiments in the present application, all the other embodiments obtained by a person of ordinary skill in the art without making any inventive effort fall within the scope of protection of the present application.

At present, when processing a task, generally, after receiving the task to be processed, the Spark SQL engine first increases the task to Yarn so as to request Yarn to allocate resources for the task. When receiving the task, Yarn shall perform processes of cluster initialization, resource allocation, etc. Moreover, with an increase of cluster size, Yarn spends more and more time in the cluster initialization, which results in the Spark SQL engine to wait for longer time.

Based on this, the present application proposes a task processing method, namely, allocating resources to the processing engine at the server in advance, and the processing engine having allocated resources shall wait for arrival of the task processing request. When receiving the task processing request, the processing engine shall process the task indicated by the task processing request in time, and in this way, waiting time for allocating resources can be saved, and concurrent performance can be greatly improved, and task processing efficiency can be enhanced.

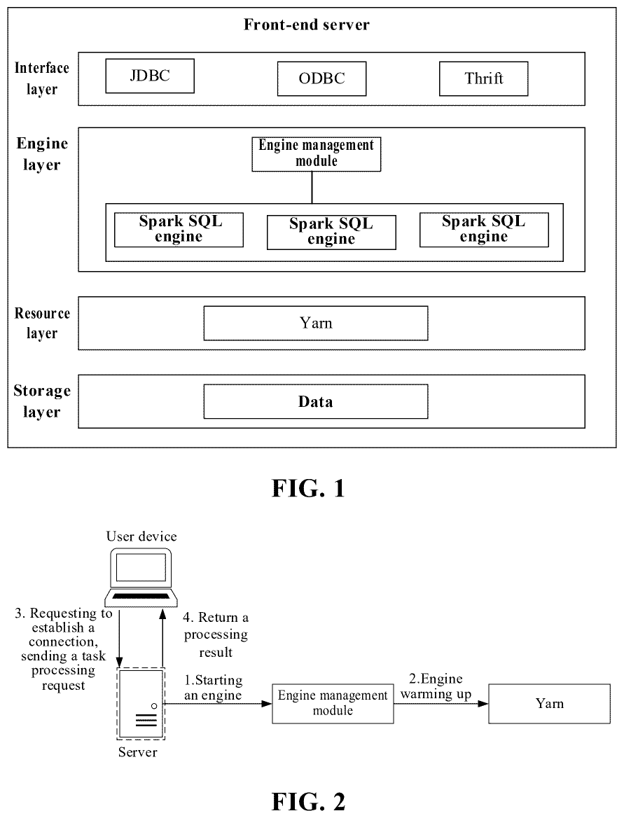

The server in the present application can be a front-end server. As shown in FIG. 1, the front-end server can comprise an interface layer, an engine layer, a resource layer and a storage layer. The interface layer supports protocols such as Java Database Connectivity (JDBC), open Database Connectivity (ODBC) and Thrift, and the user device can access the front-end server via the above-mentioned protocols. The engine layer comprises an engine management module for implementing warm-up of the Spark SQL engine. The resource layer performs resource scheduling via Yarn; the storage layer is used to store data. The Spark SQL engine can be a Thrift server, which registers with THE front-end server and is used for receiving the task processing request sent by the user device.

Based on the application scenario shown in FIG. 1, and with reference to the application scenario shown in FIG. 2, when the front-end server starts, the trigger engine management starts the Spark SQL engine, and then submits the task of engine warm-up to Yarn such that Yarn allocates resources for the Spark SQL engine. When task processing request is exists in the user device, a connection is requested to be established to the front-end server. When the connection is established, the task processing request is sent to the front-end server, and the front-end server processes the task indicated by the task processing request using the Spark SQL engine having allocated resources.

In order to facilitate an understanding of the technical solution provided by the embodiments of the present application, reference will now be made to the accompanying drawings.

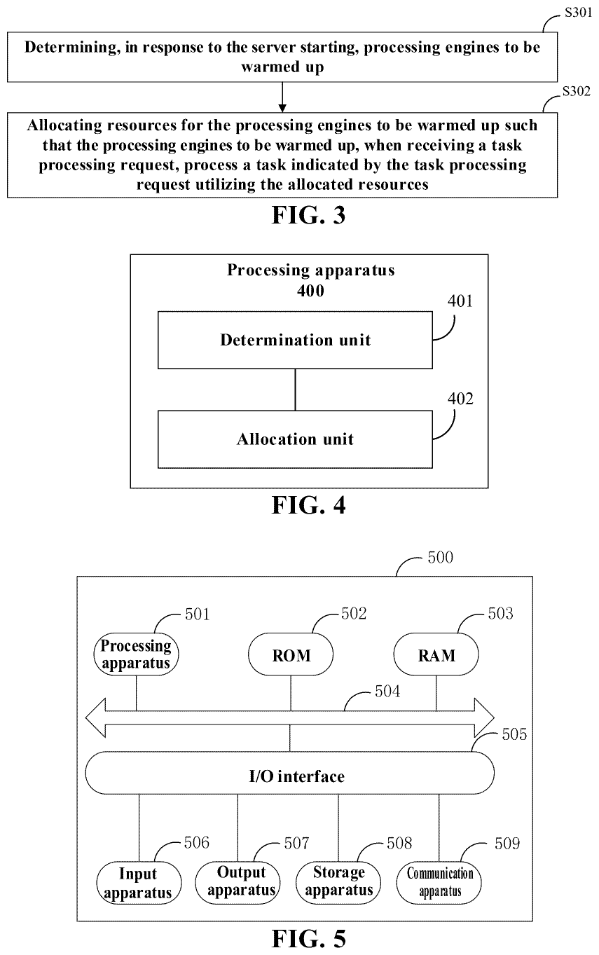

FIG. 3 is a flow chart of a task processing method according to an embodiment of the present application, and the method is applied to a server, and specifically comprises:
S301: determining, in response to the server starting, the processing engines to be warmed up.

In this embodiment, the processing engine to be warmed up will be determined when the server is started. The processing engine to be warmed up refers to a processing engine which can allocate resources in advance and wait for a task after allocating resources. For example, the processing engine to be warmed up is a Spark SQL engine with the pending task processing requests. The server may comprise a plurality of processing engines which may all be processing engines to be warmed up or part of the processing engines to be warmed up.

Alternatively, the server may determine the processing engine to be warmed up according to the following manners, specifically: determining, according to a resource amount required by one processing engine and a total resource amount corresponding to the server, a number n of processing engines to be warmed up, wherein the n is a positive integer greater than or equal to 1 and less than or equal to m, and the m is a total number of processing engines corresponding to the server.

The resource amount required by one processing engine can be determined according to the resource amount required by the processing engine in the past, for example, the historical resource allocation amounts corresponding to a processing engine S1 are respectively a1, a2 and a3, wherein a2 is the largest, and a2 can be taken as the resource amount required by the processing engine, or the average value of three values can be taken as the resource amount required by the processing engine. Or according to preset information, for example, configured default information is that the processing engine to be warmed up can allocate an resource amount a0. Since the server may correspond to a plurality of processing engines, the resource amount required by different processing engines when processing a task may be different, and in order to ensure the normal operation of each processing engine, the number of processing engines to be warmed up will be determined according to the resource amount required by the processing engine with the maximum demand.

Alternatively, the user may configure an engine management rule comprising the maximum warm-up number and the minimum warm-up number at the server in advance. When it is necessary to determine the number of the processing engines to be warmed up, the maximum resource amount and the minimum resource amount required to be allocated are determined according to the preset maximum warm-up number and the minimum warm-up number and the resource amount required by one processing engine; in response to the first ratio of the maximum resource amount to the total resource amount being less than or equal to a preset threshold, the number n of the processing engines to be warmed up is the maximum warm-up number; in response to the first ratio being greater than the preset threshold and the second ratio of the minimum resource amount to the total resource amount being less than the preset threshold, the number n of the processing engines to be warmed up is the minimum warm-up number.

The preset threshold can be set according to the actual application situation, for example, considering that Spark SQL as a calculation engine will consume a large amount of resources, but the cluster resources are not all distributed to Spark SQL, the preset threshold can be set to 60%. That is, if the first ratio of the maximum resource amount to the total resource amount is less than or equal to 60%, the configured maximum warm-up number is taken as the number of processing engines to be warmed up. If the first ratio of the maximum resource amount to the total resource amount is greater than 60% and the second ratio of the minimum resource amount to the total resource amount is less than or equal to 60%, the configured minimum warm-up numbers is taken as the number n of processing engines to be warmed up.

Alternatively, in the case where the maximum warm-up number and the minimum preset number are not configured, the number of processing engines to be warmed up is obtained by multiplying the total resource amount by the preset threshold and dividing by the resource amount required by one processing engine and rounding up.

After determining the number n of processing engines to be warmed up, n processing engines can be randomly selected from all processing engines corresponding to the server as the processing engines to be warmed up, or the first n processing engines can be selected as the processing engines to be warmed up in the order of identification of the processing engines.

S302: allocating the resources for the processing engines to be warmed up such that when receiving the task processing request, the processing engines to be warmed up process the task indicated by the task processing request using the allocated resources.

After determining the processing engines to be warmed up, allocating the resources for the processing engines to be warmed up such that the processing engines to be warmed up allocate required resources before receiving the task processing request. When receiving the task processing request, the processing engines shall process the task indicated by the task processing request with the allocated resources, and in this way, waiting time for allocating resources can be saved, and task processing efficiency can be enhanced. The allocated resources comprise a driver memory, an executor memory, the number of executors, the number of executor Cores and the number of driver Cores required when the task is executed.

Optionally, when allocating resources for the processing engines to be warmed up, the user device corresponding to the processing engine is determined for any of the processing engines to be warmed up; in response to the historical task information exists in the user device, a required resource amount according to the historical task information of the user device is determined; resources are allocated to the processing engines according to the resource amount.

In this embodiment, the processing engines can configure the corresponding user device to process the task processing request sent by the user device corresponding thereto, and when allocating resources for the processing engines, and the historical task information is existed in the user device corresponding to the processing engines, the required resource amount is determined according to the historical task information. The historical task information comprises resources allocated for executing the historical task.

Alternatively, when the historical task information is absent in the user device, resources can be allocated to the processing engines according to the preset resource allocation rule. The resource configuration rule comprises resources allocated for the processing engines and allocation amounts corresponding to different resources. For example, the resource allocation rule comprises allocating 1G of drive memory resources, allocating 1G of executor memory resources, 1 drive core, 1 executor core and 1 executor for the processing engines.

Optionally, when receiving the task processing request sent by the user device, the server selecting the first processing engine from processing engines to be warmed up; the task indicated by the request is processed by the first processing engine. That is, when the server receives the task processing request, the processing engine having allocated resources can be used to execute a task, improving task processing efficiency.

The server may randomly select one processing engine in an idle state from the processing engines to be warmed up as the first processing engine, or when all processing engines to be warmed up are in a busy state, a processing engine with a smaller load therein is selected as the first processing engine. When the first processing engine is determined, the task processing request is bound with the first processing engine, i. e., the task processing request is issued to the first processing engine such that the first processing engine processes the task indicated by the task processing request.

Alternatively, in a general case, there is a corresponding relationship between the processing engine of the server and the user device, for example, the processing engine is preset to process the task processing request sent by the user device A and the user device B. Therefore, the server selecting, from the processing engines to be warmed up, the first processing engine can specifically be: finding the matched processing engine from the processing engines to be warmed up according to the identification of the user device, and determining the matched processing engine as the first processing engine. That is, a processing engine processing the task processing request sent by the user device is found according to the identification of the user device. The task processing request comprises the identification of the user device.

For example, the processing engines to be warmed up comprise a processing engine 1, a processing engine 2 and a processing engine 3, wherein the processing engine 2 is used for processing task processing requests sent by the user device A and the user device B. After receiving the task processing request sent by the user device A, the server determines that the matched processing engine is the processing engine 2 according to the user device A, and issues the task processing request to the processing engine 2, wherein the processing engine 2 can execute the task after receiving the task processing request, and there is no need to submit the task to Yarn to wait for resource allocation.

Optionally, in response to not finding the matched processing engine, the second processing engine is selected from the processing engines that are not warmed up; resources are allocated to the second processing engine and the task indicated by the task processing request is processed with the second processing engine. That is, when none of the processing engines having allocated resources can process the task processing request sent by the user device, one processing engine (the second processing engine) is selected from the processing engines to which resources have not been allocated to request Yarn to allocate resources for the second processing engine. After the second processing engine allocates the resource, the second processing engine is used to process the task indicated by the task processing request sent by the above-mentioned user device. The task processing requests may comprise various types comprising, for example, query requests, change requests, delete requests, etc.

In the case that the server is started, during the process of starting, the server determines the processing engine which can be warmed up, i.e., the processing engine to be warmed up, in processing engines comprised by the server. After the processing engine to be warmed up is determined, the resources are allocated to the processing engine to be warmed up such that when receiving the task processing request, the processing engine to be warmed up uses the allocated resources to process the task indicated by the task processing request. That is, before the processing engine receives the task processing request, desired resources are allocated to the processing engine in advance such that when receiving the task processing request, the processing engine can execute the task in time. There is no need to wait for resource allocation, and the task execution efficiency is improved.

Based on the above embodiments, the present provide task processing apparatus, and reference will now be made to the accompanying drawings.

FIG. 4 is a schematic structural diagram of a task processing apparatus according to an embodiment of the present application. As shown in FIG. 4, the apparatus 400 comprises a determination unit 401 and an allocation unit 402.

The determination unit 401 is used for determining, in response to the server starting, the processing engines to be warmed up;

The allocation unit 402 is used for allocating the resources for the processing engines to be warmed up such that when receiving the task processing request, the processing engines to be warmed up process the task indicated by the task processing request using the allocated resources.

In one possible implementation, the apparatus further comprises: a receiving unit, a selection unit and a processing unit;
A receiving unit is used for receiving the task processing request sent by the user device;
A selection unit for selecting, from the processing engines to be warmed up, the first processing engine;
A processing unit for processing the task indicated by the task processing request using the first processing engine.

In a possible implementation, the task processing request comprises the identification of the user device, and the selection unit is specifically used for finding, from the processing engines to be warmed up and according to the identification of the user device, a matched processing engine, and determining the matched processing engine as the first processing engine.

In one possible implementation, the selection unit is further configured to select the second processing engine from the processing engines that are not warmed up in response to not finding the matched processing engine;

The allocation unit is also used for allocating the resources for the second processing engine;

The processing unit is used for processing the task indicated by the task processing request with the second processing engine.

In one possible implementation, the allocation unit 402 is specifically used for: determining, for any of the processing engines to be warmed up, the user device corresponding to the processing engine; determining, in response to the historical task information existing in the user device, the required resource amount according to the historical task information of the user device; allocating the resources for the processing engines according to the resource amount.

In a possible implementation, the allocation unit 402 is specifically used for: in response to the historical task information absent in the user device, allocating the resources to the processing engines according to the preset resource allocation rule.

In a possible implementation method, the determination unit 401 is specifically used for: determining the number n of the processing engines to be warmed up according to the resource amount required by one processing engine and the total resource amount corresponding to the server, wherein the n is greater than or equal to 1 and less than or equal to m, and the m is the total number of processing engines corresponding to the server; selecting, from all processing engines corresponding to the server, the n processing engines as the processing engines to be warmed up.

In a possible implementation method, the determination unit 401 is specifically used for: determining the maximum resource amount and the minimum resource amount required to be allocated according to the preset maximum warm-up number and the minimum warm-up number and the resource amount required by one processing engine; in response to the first ratio of the maximum resource amount to the total resource amount being less than or equal to a preset threshold, the number n of the processing engines to be warmed up is the maximum warm-up number; in response to the first ratio being greater than the preset threshold and the second ratio of the minimum resource amount to the total resource amount being less than the preset threshold, the number n of the processing engines to be warmed up is the minimum warm-up number.

In one possible implementation, the processing engines to be warmed up are Spark SQL engines with the pending task processing requests.

It should be noted that the implementation of each unit in the present embodiment can be referred to the description of the above-mentioned method embodiment, and the description of the present embodiment will not be repeated here.

Referring to FIG. 5, a schematic diagram of an electronic device 500 suitable for implementing embodiments of the present application is shown. The terminal device in the embodiment of the present application may comprise, but is not limited to, a mobile terminal such as a mobile phone, a notebook computer, a digital broadcast receiver, a PDA (Personal Digital Assistant), a PAD (portable android device), a PMP (Portable Media Player), an in-vehicle terminal (e.g., an in-vehicle navigation terminal), etc. and a fixed terminal such as a digital TV (television), a desktop computer, etc. The electronic device shown in FIG. 5 is merely an example and should not impose any limitations on the functionality and scope of use of embodiments of the present application.

As shown in FIG. 5, the electronic device 500 may comprise a processing device (e.g., central processing unit, graphics processor, etc.) 501 that may perform various suitable actions and processes in accordance with a program stored in a read only memory (ROM) 502 or a program loaded from a storage apparatus 508 into a random access memory (RAM) 503. In the RAM 503, various programs and data required for the operation of the electronic device 500 are also stored. The processing means 501, the ROM 502 and the RAM 503 are connected to each other via a bus 504. An input/output (I/O) interface 505 is also coupled to the bus 504.

In general, the following apparatus may be connected to the I/O interface 505: input apparatus 506 comprising, for example, touch screens, touch pads, keyboards, mice, cameras, microphones, accelerometers, gyroscopes, etc.; an output apparatus 507 comprising, for example, a liquid crystal display (LCD), a speaker, a vibrator, etc.; A storage apparatus 508 comprising, for example, a magnetic tape, a hard disk, etc.; and communication apparatus 509. The communication apparatus 509 may allow the electronic device 500 to communicate wirelessly or wired with other devices to exchange data. While FIG. 5 illustrates the electronic device 500 having various means, it is to be understood that not all illustrated means are required to be implemented or provided. More or fewer devices may alternatively be implemented or provided.

In particular, the processes described above with reference to flow diagrams may be implemented as a computer software program according to embodiments of the present application. For example, embodiments of the present application comprise a computer program product comprising a computer program embodied on a non-transitory computer readable medium, the computer program comprising program code for performing the method illustrated by the flowchart. In such embodiments, the computer program may be downloaded and installed from a network via communication apparatus 509, or from storage means 508, or from ROM 502. When the computer program is executed by the processing means 501, the above-described functions defined in the method of the embodiment of the present application are performed.

The electronic device provided by the embodiment of the present application belongs to the same inventive concept as the task processing method provided by the above-mentioned embodiment, and technical details not described in detail in the present embodiment can be referred to the above-mentioned embodiment, and the present embodiment has the same advantageous effects as the above-mentioned embodiment.

Embodiments of the present application provide a computer readable medium having stored thereon a computer program, wherein the program when executed by a processor implements the task processing method as described in any of the embodiments above.

Note that the computer readable medium described herein can be either a computer readable signal medium or a computer readable storage medium or any combination of the two. The computer readable storage medium can be, for example but not limited to, an electronic, magnetic, optical, electromagnetic, infrared, or semiconductor system, apparatus, or device, or a combination of any of the above. More specific examples of the computer readable storage medium may comprise, but are not limited to: an electrical connection having one or more wires, a portable computer diskette, a hard disk, a random access memory (RAM), a read-only memory (ROM), an erasable programmable read-only memory (EPROM or Flash memory), an optical fiber, a portable compact disk read-only memory (CD-ROM), an optical storage apparatus, a magnetic storage apparatus, or any suitable combination of the above. In this application, a computer readable storage medium may be any tangible medium that contains or stores a program that can be used by or in connection with an instruction execution system, apparatus, or device. In this application, a computer readable signal medium may comprise a data signal embodied in baseband or propagated as part of a carrier wave carrying computer readable program code. Such propagated data signals may take many forms, comprising but not limited to, electromagnetic signals, optical signals, or any suitable combination of the preceding. The computer readable signal medium can also be any computer readable medium other than a computer readable storage medium that can send, propagate, or transport the program for use by or in connection with the instruction execution system, apparatus, or device. The program code embodied on the computer readable medium may be transmitted over any suitable medium comprising, but not limited to: wire, fiber optic cable, RF (radio frequency), and the like, or any suitable combination of the foregoing.

In some embodiments, clients, servers may communicate using any currently known or future developed network protocol, such as HTTP (Hyper Text Transfer Protocol), and may be interconnected with any form or medium of digital data communication (e.g., a communication network). Examples of communication networks comprise local area networks (“LANs”), wide area networks (“WANs”), internetworks (e.g., the Internet), and peer-to-peer networks (e.g., ad hoc peer-to-peer networks), as well as any currently known or future developed networks.

The computer readable medium may be contained in the electronic device; it may also be present separately and not fitted into the electronic device.

The computer readable medium carries one or more programs that, when executed by the electronic device, cause the electronic device to perform the task processing method.

Computer program code for carrying out operations of the present application may be written in one or more programming languages, comprising, but not limited to, object-oriented programming languages, such as Java, smalltalk, C++, or combinations thereof, comprising conventional procedural programming languages, such as the “C” language or similar programming languages. The program code may execute entirely on the user's computer, partly on the user's computer, as a stand-alone software package, partly on the user's computer partly on a remote computer or entirely on the remote computer or server. In the case of a remote computer, the remote computer may be connected to the user's computer through any kind of network, comprising a local area network (LAN) or a wide area network (WAN), or it may be connected to an external computer (e.g., through the Internet using an Internet Service Provider).

The flowcharts and block diagrams in the figures illustrate the architecture, functionality, and operation of possible implementations of systems, methods and computer program products according to various embodiments of the present application. In this regard, each block in the flowchart or block diagrams may represent a module, segment, or portion of code, which comprises one or more executable instructions for implementing the specified logical function(s). It should also be noted that in some alternative implementations, the functions noted in the blocks may occur out of the order noted in the figures. For example, two blocks shown in succession may in fact be executed substantially concurrently or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems which perform the specified functions or operations, or combinations of special purpose hardware and computer instructions.

The units described in connection with the embodiments disclosed herein may be implemented in software or hardware. Where the name of a unit/module does not in some cases constitute a limitation on the unit itself, for example, a voice data collection module may also be described as a “data collection module”.

The functions described herein above may be performed, at least in part, by one or more hardware logic components. For example, without limitation, exemplary types of hardware logic components that may be used comprise: field Programmable Gate Arrays (FPGAs), application Specific Integrated Circuits (ASICs), application Specific Standard Products (ASSPs), systems on a Chip (SOCs), complex Programmable Logic Devices (CPLDs), and the like.

In the context of this application, a machine readable medium may be a tangible medium that may contain or store a program for use by or in connection with an instruction execution system, apparatus, or device. The machine readable medium may be a machine readable signal medium or a machine readable storage medium. The machine readable medium may comprise, but is not limited to, an electronic, magnetic, optical, electromagnetic, infrared, or semiconductor system, apparatus, or device, or any suitable combination of the preceding. More specific examples of a machine readable storage medium would comprise an electrical connection based on one or more wires, a portable computer diskette, a hard disk, a random access memory (RAM), a read-only memory (ROM), an erasable programmable read-only memory (EPROM or Flash memory), an optical fiber, a compact disc read-only memory (CD-ROM), an optical storage apparatus, a magnetic storage apparatus, or any suitable combination of the preceding.

According to one or more embodiments of the present application, the task processing method is provided, the method being applied to a server, and may comprise:
determining, in response to the server starting, the processing engines to be warmed up;
allocating the resources for the processing engines to be warmed up such that when receiving the task processing request, the processing engines to be warmed up process the task indicated by the task processing request using the allocated resources.

According to one or more embodiments of the present application, the method further comprises:
receiving the task processing request sent by the user device;
selecting, from the processing engines to be warmed up, the first processing engine;
processing the task indicated by the task processing request with the first processing engine.

According to one or more embodiments of the present application, the task processing request comprises the identification of the user device, and selecting, from the processing engines to be warmed up, the first processing engine comprising:
finding the matched processing engine from the processing engines to be warmed up according to the identification of the user device, and determining the matched processing engine as the first processing engine.

According to one or more embodiments of the present application, the method further comprises:
in response to not finding the matched processing engine, selecting the second processing engine from processing engines that are not warmed up;
allocating resources for the second processing engine, and processing the task indicated by the task processing request with the second processing engine.

According to one or more embodiments of the present application, the allocating the resources for the processing engine to be warmed up comprises:
determining, for any of the processing engines to be warmed up, the user device corresponding to the processing engine;
determining, in response to the historical task information existing in the user device, the required resource amount according to the historical task information of the user device;
allocating the resources for the processing engines according to the resource amount.

According to one or more embodiments of the present application, the method further comprises:
in response to the historical task information absent in the user device, allocating the resources to the processing engines according to the preset resource allocation rule.

According to one or more embodiments of the present application, the determining, in response to the server starting, processing engines to be warmed up comprises:
determining the number n of the processing engines to be warmed up according to the resource amount required by one processing engine and the total resource amount corresponding to the server, wherein the n is a positive integer greater than or equal to 1 and less than or equal to m, and the m is a total number of processing engines corresponding to the server;
selecting, from all processing engines corresponding to the server, the n processing engines as processing engines to be warmed up.

According to one or more embodiments of the present application, the determining the number n of the processing engines to be warmed up according to the resource amount required by one processing engine and the total resource amount corresponding to the server comprises:
determining the maximum resource amount and the minimum resource amount required to be allocated according to the preset maximum warm-up number, the minimum warm-up number and the resource amount required by the one processing engine;
in response to the first ratio of the maximum resource amount to the total resource amount being less than or equal to the preset threshold, the number n of the processing engines to be warmed up being the maximum warm-up number;
in response to the first ratio being greater than the preset threshold and the second ratio of the minimum resource amount to the total resource amount being less than or equal to the preset threshold, the number n of the processing engines to be warmed up being the minimum warm-up number.

According to one or more embodiments of the present application, the processing engines to be warmed up are Spark SQL engines with the pending task processing requests.

According to one or more embodiments of the present application, the task processing apparatus is provided, the apparatus being applied to the server, comprising:
the determination unit for determining, in response to the server starting, the processing engines to be warmed up;
the allocation unit for allocating the resources for the processing engines to be warmed up such that when receiving the task processing request, the processing engines to be warmed up process the task indicated by the task processing request using the allocated resources.

According to one or more embodiments of the present application, the apparatus further comprises: the receiving unit, the selection unit and the processing unit;
The receiving unit is used for receiving the task processing request sent by the user device;
The selection unit for selecting, from the processing engines to be warmed up, the first processing engine;
The processing unit for processing the task indicated by the task processing request using the first processing engine.

According to one or more embodiments of the present application, the task processing request comprises the identification of the user device, and the selection unit is specifically used for finding for the matched processing engine from the processing engines to be warmed up according to the identification of the user device, and determining the matched processing engine as the first processing engine.

According to one or more embodiments of the present application, the selection unit is further used for selecting the second processing engine from the processing engines that are not warmed up in response to not finding the matched processing engine;
The allocation unit is also used for allocating the resources for the second processing engine;
The processing unit is used for processing the task indicated by the task processing request with the second processing engine.

According to one or more embodiments of the present application, the allocation unit is specifically used for: determining, for any of the processing engines to be warmed up, the user device corresponding to the processing engine; determining, in response to the historical task information existing in the user device, the required resource amount according to the historical task information of the user device; allocating the resources for the processing engines according to the resource amount.

According to one or more embodiments of the present application, the allocation unit 402 is specifically used for: allocating, in response to the historical task information absent in the user device, the resources for the processing engines according to a preset resource allocation rule.

According to one or more embodiments of the present application, the determination unit is specifically used for: determining the number n of the processing engines to be warmed up according to the resource amount required by one processing engine and the total resource amount corresponding to the server, wherein the n is greater than or equal to 1 and less than or equal to m, and the m is the total number of processing engines corresponding to the server; selecting, from all processing engines corresponding to the server, the n processing engines as the processing engines to be warmed up.

According to one or more embodiments of the present application, the determination unit is specifically used for: determining the maximum resource amount and the minimum resource amount required to be allocated according to the preset maximum warm-up number and the minimum warm-up number and the resource amount required by one processing engine; in response to the first ratio of the maximum resource amount to the total resource amount being less than or equal to a preset threshold, the number n of the processing engines to be warmed up is the maximum warm-up number; in response to the first ratio being greater than the preset threshold and the second ratio of the minimum resource amount to the total resource amount being less than the preset threshold, the number n of the processing engines to be warmed up is the minimum warm-up number.

According to one or more embodiments of the present application, the processing engines to be warmed up are Spark SQL engines with the pending task processing requests.

According to one or more embodiments of the present application, the processing engines to be warmed up are Spark SQL engines with the pending task processing requests.

It is noted that the various embodiments described in this specification are presented in a progressive manner, with each embodiment being specifically illustrated as a departure from the other embodiments, and that like reference numerals refer to like elements throughout. The system or apparatus disclosed in the examples is relatively simple to describe because it corresponds to the method disclosed in the examples, with respect to which reference is made to the description in the method section.

It should be understood that in this application, “at least one” means one or more, and “plurality” means two or more. “And/or”, used to describe an associated relationship of an associated object, means that there may be three relationships, for example, “A and/or B” may mean: there are only three cases of A, only B and both A and B, wherein A and B can be singular or plural. The character “/” generally indicates that the context object is an OR relationship. “At least one of”, or the like, means any combination of these items, comprising any combination of single items or plural items. For example, at least one (one) of a, b or c may represent: a, b, c, “a and b”, “a and c”, “b and c”, or “a and b and c”, wherein a, b, c may be single or multiple.

It is further noted that the use of relational terms such as first and second, and the like herein, are used solely to distinguish one entity or action from another entity or action without necessarily requiring or implying any actual such relationship or order between such entities or actions. Furthermore, the terms “comprises”, “comprising”, or any other variation thereof, are intended to cover a non-exclusive inclusion, such that a process, method, article, or apparatus that comprises a list of elements does not comprise only those elements but may comprise other elements not expressly listed or inherent to such process, method, article, or apparatus. An element proceeded by “comprises a . . . ” does not, without more constraints, preclude the existence of additional identical elements in the process, method, article, or apparatus that comprises the element.

The steps of a method or algorithm described in connection with the embodiments disclosed herein may be embodied directly in hardware, in a software module executed by a processor, or in a combination of the two. A software module may reside in Random Access Memory (RAM), memory, read Only Memory (ROM), electrically programmable ROM, electrically erasable programmable ROM, registers, hard disk, a removable disk, a CD-ROM, or any other form of storage medium known in the art.

The previous description of the disclosed embodiments is provided to enable any person skilled in the art to make or use the present application. Various modifications to these embodiments will be readily apparent to those skilled in the art, and the generic principles defined herein may be implemented in other embodiments without departing from the spirit or scope of the application. Thus, the present application is not intended to be limited to the embodiments shown herein but is to be accorded the widest scope consistent with the principles and novel features disclosed herein.

1. A task processing method, wherein the method is applied to a server, and the method comprises:
determining, in response to the server starting, processing engines to be warmed up;
allocating resources for the processing engines to be warmed up such that the processing engines to be warmed up, when receiving a task processing request, process a task indicated by the task processing request utilizing allocated resources.

2. The method of claim 1, further comprising:
receiving the task processing request sent by a user device;
selecting, from the processing engines to be warmed up, a first processing engine;
processing the task indicated by the task processing request with the first processing engine.

3. The method of claim 2, wherein the task processing request comprises an identification of the user device, and selecting, from the processing engines to be warmed up, a first processing engine comprises:
finding, from the processing engines to be warmed up and according to the identification of the user device, a matched processing engine, and determining the matched processing engine as the first processing engine.

4. The method of claim 3, further comprising:
selecting, in response to not finding the matched processing engine, a second processing engine from processing engines that are not warmed up;
allocating resources for the second processing engine, and processing the task indicated by the task processing request with the second processing engine.

5. The method of claim 1, wherein allocating resources for the processing engines to be warmed up comprises:
determining, for any of the processing engines to be warmed up, determining a user device corresponding to the processing engine;
determining, in response to historical task information existing in the user device, a required resource amount according to the historical task information of the user device;
allocating resources for the processing engines according to the resource amount.

6. The method of claim 5, further comprising:
allocating, in response to historical task information absent in the user device, resources for the processing engines according to a preset resource allocation rule.

7. The method of claim 1 wherein determining, in response to the server starting, processing engines to be warmed up comprises:
determining, according to a resource amount required by one processing engine and a total resource amount corresponding to the server, a number n of processing engines to be warmed up, wherein the n is a positive integer greater than or equal to 1 and less than or equal to m, and the m is a total number of processing engines corresponding to the server;
selecting, from all processing engines corresponding to the server, the n processing engines as processing engines to be warmed up.

8. The method according to claim 7, wherein determining, according to a resource amount required by one processing engine to be warmed up and a total resource amount corresponding to the server, a number n of processing engines to be warmed up comprises:
determining, according to a preset maximum warm-up number, a minimum warm-up number, and a resource amount required by the one processing engine, a maximum resource amount and a minimum resource amount required to be allocated;
in response to a first ratio of the maximum resource amount to the total resource amount being less than or equal to a preset threshold, the number n of the processing engines to be warmed up being the maximum warm-up number;
in response to the first ratio being greater than the preset threshold and a second ratio of the minimum resource amount to the total resource amount being less than or equal to the preset threshold, the number n of the processing engines to be warmed up being the minimum warm-up number.

9. The method of claim 1, wherein the processing engines to be warmed up are Spark SQL engines with pending task processing requests.

10. (canceled)

11. An electronic device comprising: a processor and a memory;
the memory for storing instructions or a computer program;
the processor for executing the instructions or the computer program in the memory to cause the electronic device to perform a task processing method comprising:
determining, in response to the server starting, processing engines to be warmed up;
allocating resources for the processing engines to be warmed up such that the processing engines to be warmed up, when receiving a task processing request, process a task indicated by the task processing request utilizing allocated resources.

12. A computer readable storage medium having stored therein instructions which, when executed on a device, cause the device to perform a task processing method comprising:
determining, in response to the server starting, processing engines to be warmed up;
allocating resources for the processing engines to be warmed up such that the processing engines to be warmed up, when receiving a task processing request, process a task indicated by the task processing request utilizing allocated resources.

13. (canceled)

14. The electronic device of claim 11, wherein the method further comprises:
receiving the task processing request sent by a user device;
selecting, from the processing engines to be warmed up, a first processing engine;
processing the task indicated by the task processing request with the first processing engine.

15. The electronic device of claim 11, wherein the task processing request comprises an identification of the user device, and selecting, from the processing engines to be warmed up, a first processing engine comprises:
finding, from the processing engines to be warmed up and according to the identification of the user device, a matched processing engine, and determining the matched processing engine as the first processing engine.

16. The electronic device of claim 11, wherein the method further comprises:
selecting, in response to not finding the matched processing engine, a second processing engine from processing engines that are not warmed up;
allocating resources for the second processing engine, and processing the task indicated by the task processing request with the second processing engine.

17. The electronic device of claim 11, wherein allocating resources for the processing engines to be warmed up comprises:
determining, for any of the processing engines to be warmed up, determining a user device corresponding to the processing engine;
determining, in response to historical task information existing in the user device, a required resource amount according to the historical task information of the user device;
allocating resources for the processing engines according to the resource amount.

18. The electronic device of claim 14, wherein the method further comprises:
allocating, in response to historical task information absent in the user device, resources for the processing engines according to a preset resource allocation rule.

19. The electronic device of claim 11 wherein determining, in response to the server starting, processing engines to be warmed up comprises:
determining, according to a resource amount required by one processing engine and a total resource amount corresponding to the server, a number n of processing engines to be warmed up, wherein the n is a positive integer greater than or equal to 1 and less than or equal to m, and the m is a total number of processing engines corresponding to the server;
selecting, from all processing engines corresponding to the server, the n processing engines as processing engines to be warmed up.

20. The electronic device according to claim 16, wherein determining, according to a resource amount required by one processing engine to be warmed up and a total resource amount corresponding to the server, a number n of processing engines to be warmed up comprises:
determining, according to a preset maximum warm-up number, a minimum warm-up number, and a resource amount required by the one processing engine, a maximum resource amount and a minimum resource amount required to be allocated;
in response to a first ratio of the maximum resource amount to the total resource amount being less than or equal to a preset threshold, the number n of the processing engines to be warmed up being the maximum warm-up number;
in response to the first ratio being greater than the preset threshold and a second ratio of the minimum resource amount to the total resource amount being less than or equal to the preset threshold, the number n of the processing engines to be warmed up being the minimum warm-up number.

21. The electronic device of claim 11, wherein the processing engines to be warmed up are Spark SQL engines with pending task processing requests.

22. The computer readable storage medium of claim 12, the method further comprises:
receiving the task processing request sent by a user device;
selecting, from the processing engines to be warmed up, a first processing engine;
processing the task indicated by the task processing request with the first processing engine.
